(19) United States
(12) Patent Application Publication
(10) Pub. No.: US 2013/0058079 A1
(43) Pub. Date: Mar. 7, 2013

(54) LIGHTING DEVICE

(71) Applicants: Harald Dellian, Edling (DE); Robert Kreutmayr, Affing (DE)

(72) Inventors: Harald Dellian, Edling (DE); Robert Kreutmayr, Affing (DE)

(73) Assignee: OSRAM AG, Muenchen (DE)

(21) Appl. No.: 13/580,382

(22) PCT Filed: Feb. 3, 2011
(86) PCT No.: PCT/EP2011/051607

§ 371 Date: Nov. 7, 2012

(30) Foreign Application Priority Data
Feb. 23, 2010 (DE) 10 2010 002 228.4

(51) Int. Cl. F21V 21/00

(52) U.S. Cl. 362/217.14; 362/249.06; 362/249.14

(57) ABSTRACT

In various embodiments, a lighting device may include at least one current-controlling device and at least two arrangements of at least one monochromatic light source in each case, wherein the light sources of both arrangements have approximately the same light color wherein at least one light source of one arrangement of light sources in each case has an active thermal connection to at least one light source or at least one further arrangement.

The invention relates to a lighting device including at least one current-controlling device and at least two arrangements of at least one monochromatic light source in each case, preferably at least one monochromatic light-emitting diode, wherein the light sources in both arrangements have approximately the same light color, preferably white.

Lighting devices often feature light sources such as e.g. light-emitting diodes (LEDs) that require a constant operating current, and are therefore equipped with at least one current-controlling device which adjusts the operating current to a desired value for the light sources. This can be done without difficulty if the lighting device has only one light source per current-controlling device or if all light sources of the lighting device are connected in series. However, the lighting device often has to feature a multiplicity of light sources in order to achieve the desired illuminance, and it is therefore no longer possible for said light sources to be connected in series without requiring an unacceptably high operating voltage, for example. Such a series circuit is also extremely vulnerable in respect of faults, since the failure of a single light source is sufficient to render the entire lighting device inoperable.

In lighting devices including a multiplicity of light sources, particularly if these are light-emitting diodes, use is frequently made of two or more arrangements of light sources, in particular strings of series-connected light-emitting diodes, said strings being connected to each other in parallel. In order to achieve a homogeneous illumination effect in this context, it is however important for the light sources in each string to emit the same power, i.e. for the current in all strings to be approximately the same when approximately the same light sources are used (as is generally the case in practice). This is not normally possible when a plurality of strings are simply connected in parallel, since the differences in light sources, mounting location, operating temperature, etc. usually cause the currents in the strings (and hence the illuminance) to differ.

For this purpose, measures are usually taken downstream of the current-controlling device in each string in order to achieve a uniform current distribution, e.g. by means of series-connected resistors and transistors (cf. Power Supplies for LED Driving, Steve Winder, Newnes Verlag, ISBN: 978-0-7506-8341-8, pages 26-27). However, disadvantages here include both the increased cost of circuitry and hence manufacturing and the far greater power losses, which can be in the order of 20%.

The present invention therefore addresses the problem of providing a lighting device including at least one current- controlling device and at least two arrangements of at least one monochromatic light source in each case, preferably at least one monochromatic light-emitting diode, wherein the light sources of both arrangements have approximately the same light color (preferably white), which lighting device allows light of one light color from a plurality of light sources to be emitted with maximal homogeneity, i.e. with approximately the same brightness and/or light color of the individual light sources, while incurring low circuitry costs and minimal power loss. In this case, monochromatic light sources are considered to be light sources (in particular LEDs) that are not able to selectively change their light color.

This problem is solved by a lighting device as claimed in claim 1. Preferred embodiments can be derived from the dependent claims in particular.

By virtue of at least one light source of one arrangement of light sources having in each case an active thermal connection (in particular being thermally coupled) to at least one light source of at least one further arrangement, a temperature equalization occurs between the light sources of the different arrangements. In this context, thermally coupled light sources are considered to be those in respect of which suitable means ensure that particularly good heat conduction is possible between the light sources, such that a temperature difference can quickly be equalized. Said means may include e.g. a direct connection of the light sources or connection by means of a material having high thermal conductivity, in particular a thermal conductivity of more than 25 W/mK, in particular more than 100 W/mK, or other type of connection having a thermal conductivity of more than 25 W/mK, in particular more than 100 W/mK.

It has been shown that the temperature of the individual light sources (particularly if these are LEDs) is a critical variable for the current consumption in the individual arrangements. Conversely, other variables such as e.g. the forward voltage of the LED can be ignored since, although they vary from light source to light source, the effect nonetheless evens out over the individual arrangements of the light sources. The thermal coupling of the light sources of different arrangements results in a temperature equalization between them, such that the current through the light sources of the different arrangements is practically identical, and the light radiation characteristics of the light sources used therein are therefore likewise practically identical. It has been shown that as a result of thermal coupling, the operating current of LEDs over an operating period of 600 s varies by no more than 6 mA and/or 10%, in particular by no more than 4 mA and/or 7%, and this can therefore be considered as an indication of successful thermal coupling.

It is evidently particularly advantageous for at least one arrangement of light sources to include at least one series circuit of light sources, in particular light-emitting diodes. In a series circuit, the current through all of the elements of the circuit is identical, and therefore a homogeneous light radiation can be achieved within the series. It is also possible to apply a significantly higher voltage to a series circuit than the operating voltage of the individual elements, such that a far smaller reduction in the supply voltage is required than if the elements were connected in parallel, for example.

Moreover, it is evidently appropriate for the lighting device to include more than three arrangements of light sources. As the number of arrangements increases, the failure of one arrangement (e.g. due to failure of a light source) has far less effect on the power of the overall lighting device, and if there are more than three arrangements featuring standard LEDs, a sufficient number of LEDs can be combined in an arrangement to achieve a sufficiently high illuminance without requiring excessively high values for the supply voltage.

It is also advantageous for the lighting device to include fewer than seven arrangements of light sources. A greater number of arrangements makes it difficult to achieve the thermal equalization between the individual arrangements. The manufacturing cost also increases significantly, in particular due to the multiplicity of leads that are required.

It is appropriate for at least one arrangement to be formed exclusively from the series-connected light sources. A particularly simple structure can be achieved if the arrangements include no components other than the light sources that are used therein and the leads for connecting them, in particular no electrical and/or electronic components.

It is likewise appropriate for at least one arrangement to include a multiplicity of light sources, in particular more than five, preferably more than 10, particularly preferably more than 15 light sources.

Moreover, it is advantageous for at least one light source of a different arrangement to be arranged between at least two light sources of the same arrangement. This allows a particularly good heat transfer between the light sources of different arrangements, since they are arranged adjacently to each other. This also prevents light sources of one arrangement from being arranged adjacently to each other, thereby preventing a region of the lighting device from including only light sources of one arrangement and hence the development there of a temperature that is significantly different than that of other regions. In the context of this application, adjacent signifies that, in addition to a direct spatial arrangement, the light sources are also thermally adjacent, i.e. that heat from one light source flows more efficiently to an adjacent light source than to a light source that is not adjacent.

Moreover, it is appropriate for the light sources of the arrangements to be arranged in the sequence of the arrangements. This means that in the case of three arrangements, for example, a light source of the first arrangement is adjacent to a light source of the second arrangement, which in turn is adjacent to a light source of a third arrangement in addition to the light source of the first arrangement. The light source of the third arrangement is in turn adjacent to a light source of the first arrangement, wherein this can be the first light source but will preferably be a second light source of the first arrangement, thereby continuing this pattern.

It is likewise advantageous for no two light sources within an arrangement to be arranged adjacently. Particularly good temperature distribution is achieved in this way, since light sources of an arrangement are prevented from being arranged adjacently to each other. Consequently, no region of the lighting device contains only light sources of one arrangement, and no temperature can develop there that is significantly different than that in other regions.

Moreover, it is advantageous for all LEDs within at least one arrangement, in particular within all arrangements, to be taken from the same manufacturing batch. As a result, they have very similar properties and a particularly homogeneous lighting effect can be created. In particular, the light color, the forward voltage and the temperature influence on the operating characteristics are for the most part particularly similar in the case of LEDs from a manufacturing batch. This applies all the more if all LEDs of the lighting device are taken from the same manufacturing batch.

It is advantageous for at least two arrangements, preferably all arrangements, of the lighting device to have the same number of light sources. A particularly simple structure is achieved thus. This also prevents light sources of one arrangement from being more numerous than those of other arrangements, which could contribute to an inhomogeneity of the temperature distribution, since light sources of the one arrangement would then necessarily occur in larger numbers locally.

It is advantageous for at least one light source to be arranged on at least one circuit support, since this makes it possible to achieve a particularly simple structure in which particularly simple contacting of the light sources can be effected. A particularly simple structure is achieved if all light sources are arranged on the same circuit support.

A particularly simple and economical structure is achieved if at least one circuit support takes the form of an FR4 circuit board.

However, it can also be advantageous for at least one circuit support to take the form of a metal circuit board or a metal-core circuit board. Such circuit boards facilitate the lateral heat transfer between the light sources and therefore improve their thermal coupling.

Moreover, it is advantageous for at least one circuit support to be arranged on at least one heat sink. The cooling of the light-emitting diodes is thereby improved and their efficiency level is therefore increased. Moreover, by virtue of its good thermal conductivity, the heat sink provides the thermal coupling between the light sources that have an active thermal connection to the heat sink.

It is appropriate for the distance between the plurality of light sources, in particular between all light sources, to be identical. Particularly homogeneous heat distribution can be achieved in this way.

In an advantageous embodiment of the invention, the light sources are arranged linearly. A linear arrangement represents a particularly simple arrangement which is suitable for a linear lighting device in particular. However, a linear arrangement that is wound into a ring or a spiral can also be advantageous when using a flexible circuit support in particular.

In a further advantageous embodiment of the invention, the light sources are arranged in the form of a matrix. This means that the light sources are arranged in a regular planar grid, e.g. a cubic or hexagonal grid, whereby a planiform lighting device giving homogeneous light distribution can be achieved particularly effectively.

Moreover, it is advantageous for the lighting device to feature at least one standard base section, in particular a pin-type base section. The lighting device can then be installed in a standard socket and used as a replacement for a conventional lamp, e.g. an incandescent lamp or a fluorescent lamp.

In a particularly advantageous embodiment of the invention, the lighting device is intended as a replacement for a fluorescent lamp. In particular, this means that in addition to a suitable base section (e.g. a T8 or T5 pin-type base section), the lighting device preferably also includes means (e.g. in the form of a circuit) whereby it can be operated in a lighting fixture that is intended for fluorescent lamps, i.e. whereby the operating voltage of the fluorescent lamp is converted into an operating voltage for the light sources of the lighting device, in particular for LEDs.

The invention is described in greater detail schematically in the following figures with reference to exemplary embodiments. For the sake of greater clarity, identical or functionally identical elements may be denoted by identical reference signs in this case.

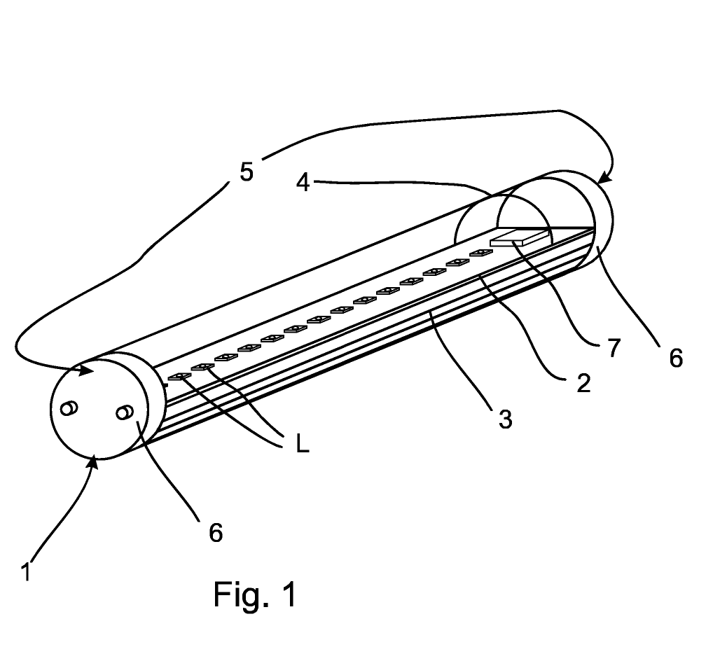

FIG. 1 shows a schematic illustration of a lighting device according to the invention;

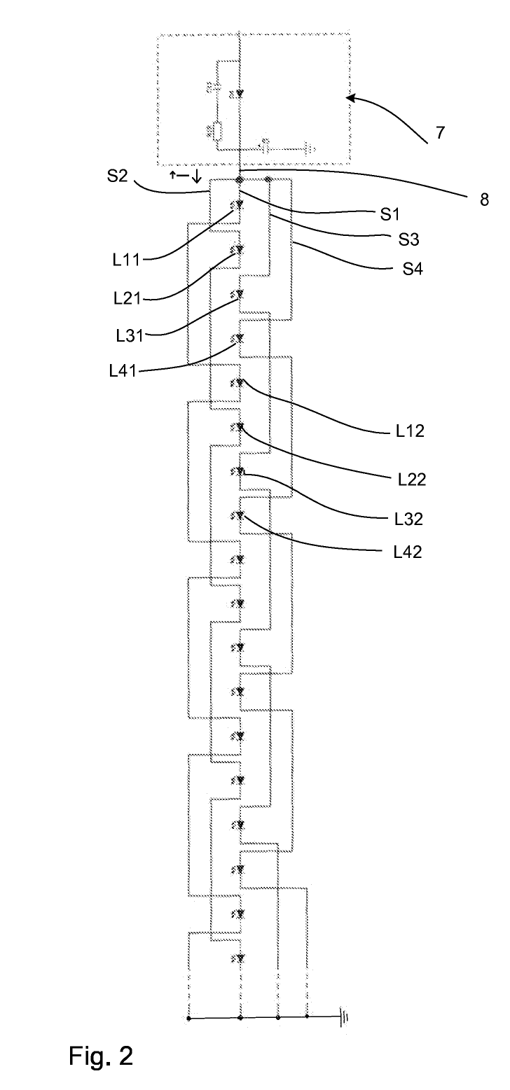

FIG. 2 schematically shows the circuit diagram of a lighting device according to the invention.

FIG. 1 schematically shows part of a sectional view of a lighting device 1 according to the invention. The lighting device 1 is designed as an LED retrofit lamp 1 for a T8 fluorescent lamp and features a linear extension accordingly. The geometric arrangement is selected such that the light-emitting diodes L are arranged on an FR4 support 2 in a straight row, wherein the FR support 2 is suitably fastened to an end-to-end heat sink 3 in order to allow an effective heat transfer from the light-emitting diodes L onto the heat sink 3 and thus to create a thermal coupling between the LEDs L. The LED retrofit lamp 1 is enclosed at the top by means of a diffusion element 4, this being shown here in a cutaway view for greater clarity. In this case, the distance between the LEDs L is so selected as to achieve maximal homogeneity of illumination by the diffusion element 4 and a good thermal coupling between the LEDs. The LEDs L are separated from each other by the same distance, this being no greater than the distance of the LEDs L from the diffusion element 4 in order to ensure homogeneous illumination by the diffusion element 4. T8 pin-type base sections 6 are arranged at the end faces 5 of the lighting device 1 and a driver circuit 7 is arranged at one end.

FIG. 2 shows a circuit diagram of the lighting device 1 according to the invention. The driver circuit 7 is provided as a current-controlling device and feeds a constant current I into the supply line 8. The supply line 8 branches into four strings S1, S2, S3, S4, each of which forms an arrangement of light-emitting diodes L as light sources. The light-emitting diodes L are connected in series within the strings S1, S2, S3, S4. The light-emitting diodes L are arranged according to the sequence of the strings S1, S2, S3, S4. This means that a light-emitting diode L11 of the string S1 is followed by a light-emitting diode L21 of the string S2 and this is followed by a light-emitting diode L31 of the string S3. The light-emitting diode L31 is followed by a light-emitting diode L41 of the string S4 and this in turn is followed by a light-emitting diode L12 of the string S1. This results in a plait-like interlacing of the strings S1, S2, S3, S4 and therefore an ideal thermal equalization between the strings S1, S2, S3, S4.

The present invention is obviously not restricted to the exemplary embodiments illustrated here. Other arrangements are also conceivable, e.g. other sequences can be selected instead of the illustrated sequence 1-2-3-4-1 . . . , such as e.g. 1-2-3- 4-2-1-3-4-1-3-2-4 . . . , though it is more difficult in this case to ensure that the LEDs of the respective strings are arranged at a defined distance from each other.

The heat sink 3 is made of aluminum in the present exemplary embodiment, though any other materials known to a person skilled in the art can be used for this purpose, e.g. copper. Likewise, a person skilled in the art will also consider other circuit board designs and materials instead of the FR4 circuit board 2, e.g. metal-core circuit boards or even flexible circuit boards which can be attached to a curved heat sink, for example. This is conceivable in the case of retrofit lamps in particular, which can be inserted into a screw socket or bayonet socket instead of conventional incandescent lamps.

1. A lighting device, comprising:
at least one current-controlling device and at least two arrangements of at least one monochromatic light source in each case, wherein the light sources of both arrangements have approximately the same light color,
wherein at least one light source of one arrangement of light sources in each case has an active thermal connection to at least one light source of at least one further arrangement.

2. The lighting device as claimed in claim 1, wherein at least one arrangement of light sources comprises at least one series circuit of light sources.

3. The lighting device as claimed in claim 1, wherein the lighting device has more than three arrangements of light sources.

4. The lighting device as claimed in claim 1,
wherein the lighting device has fewer than seven) arrangements of light sources.

5. The lighting device as claimed in claim 1,
wherein at least one arrangement is formed from series-connected light sources.

6. The lighting device as claimed in claim 1,
wherein at least one arrangement comprises a multiplicity of light sources.

7. The lighting device as claimed in claim 1,
wherein at least one light source of a different arrangement is arranged between at least two light sources of the same arrangement.

8. The lighting device as claimed in claim 1,
wherein the light sources of the arrangements are arranged in the sequence of the arrangements.

9. The lighting device as claimed in claim 1,
wherein no two light sources of an arrangement are arranged adjacently to each other within the arrangement.

10. The lighting device as claimed in claim 1,
wherein all light emitting diodes within at least one arrangement are taken from the same manufacturing batch.

11. The lighting device as claimed in claim 1,
wherein at least two arrangements of the lighting device have the same number of light sources.

12. The lighting device as claimed in claim 1,
wherein at least one light source is arranged on at least one circuit support.

13. The lighting device as claimed in claim 1,
wherein at least one circuit support is arranged on at least one heat sink.

14. The lighting device as claimed in claim 1,
wherein the lighting device features at least one standard base section.

15. The lighting device as claimed in claim 1,
wherein the lighting device is provided as a replacement for a fluorescent lamp.

16. The lighting device as claimed in claim 1,
wherein the at least one monochromatic light source comprises at least one light-emitting diode.

17. The lighting device as claimed in claim 1,
wherein the same light color is white.

18. The lighting device as claimed in claim 6,
wherein the at least one arrangement comprises a more than five light sources.

19. The lighting device as claimed in claim 10,
wherein all light emitting diodes within all arrangements are taken from the same manufacturing batch.

20. The lighting device as claimed in claim 11,
wherein all arrangements of the lighting device have the same number of light sources.
